(19) United States
(12) Patent Application Publication
(10) Pub. No.: US 2007/0278445 A1
(43) Pub. Date: Dec. 6, 2007

(54) Smart material

(75) Inventor: Vladimir Vlad, Ames, IA (US)

Correspondence Address: MCKEE, VOORHEES & SEASE, P.L.C., 801 GRAND AVENUE, SUITE 3200, DES MOINES, IA, 50309-2721, US

(73) Assignee: Glycon Technologies, L.L.C., Ames, IA (US)

(21) Appl. No.: 11/338,256

(22) Filed: Jan. 24, 2006

Related U.S. Application Data
(60) Provisional application No. 60/646,265, filed on Jan. 24, 2005.

(51) Int. Cl. H01F 1/00; H01B 1/00

(52) U.S. Cl. 252/62.51 R; 252/500; 252/517

(57) ABSTRACT

A composition is made from a mixture of an electroactive powder and a conductive liquid. The conductive liquid can be an elastomer such as rubber, or a polymeric foam. The electroactive powder may be an electroceramic powder or a magnetostrictive material. One example of a magnetostrictive material is a Terbium alloy. The composition can have an open cell structure or a closed cell structure. In addition to the electroactive powder and the conductive liquid, carbon nanotubes can be added to the mixture. A method is also provided. The method includes forming a smart material composition includes adding an electroactive powder to a conductive liquid and mixing the electroactive powder and the conductive liquid to form a mixture.

### PRIORITY STATEMENT

This application claims priority to U.S. Provisional Ser. No. 60/646,265, filed Jan. 24, 2005, hereby incorporated by reference in its entirety.

### BACKGROUND OF THE INVENTION

The present invention relates to smart materials. The present invention provides a solution to solving a number of diverse problems. In particular, the materials produced by the present invention can find countless applications in a number of wide-ranging contexts.

One problem addressed by the present invention relates to the use of electroactive materials as sources of electrical energy. Although electroactive materials, including piezoelectrics are widely used for producing an electrical signal from mechanical forces applied to the electroactive material, this property is generally only used to produce sensors. One of the reasons is that the resulting electrical signals produced typically have such a low current that it is not practical to use the resulting electrical signals as a source of power. Therefore, despite the existence of numerous electroactive materials, problems remain.

Therefore, it is a primary object, feature, or advantage of the present invention to improve upon the state of the art.

It is a further object, feature, or advantage of the present invention to provide a smart material that is practical to use as a source of electrical energy.

Another object, feature, or advantage of the present invention is to provide a smart material that is easy to manufacture.

A further object, feature, or advantage of the present invention is to provide a smart material that can be applied in numerous applications and contexts.

Yet another object, feature, or advantage of the present invention is to provide a smart material having a cell structure.

One or more of these and/or other objects, features, or advantages of the present invention will become apparent from the specification and claims that follow.

### SUMMARY OF THE INVENTION

According to one aspect of the present invention a composition comprised of a mixture of an electroactive powder and a conductive liquid is provided. The mixture is a substantially homogenized mixture. The conductive liquid can be an elastomer such as rubber, or a polymeric foam. The mixture is cured. The electroactive powder may be an electroceramic powder or a magnetostrictive material. One example of a magnetostrictive material is a Terbium alloy. The composition can have an open cell structure or a closed cell structure. In addition to the electroactive powder and the conductive liquid, carbon nanotubes can be added to the mixture.

According to another aspect of the present invention, a method of forming a smart material composition includes adding an electroactive powder to a conductive liquid and mixing the electroactive powder and the conductive liquid to form a mixture. The method can further include curing the mixture. Preferably the step of mixing is mixing until substantially homogenous. A voltage is applied to the mixture prior to curing in order to polarize the mixture. Alignment of the structure of the mixture can also be performed. Curing and alignment can be performed within a mold. Alternatively, film extrusion can be performed on the mixture to produce a sheet of material. A conductor can be deposited in a pattern on the sheet. One example of a pattern that can be used is a coil pattern.

### BRIEF DESCRIPTION OF THE DRAWINGS

FIG. 1 is a diagram illustrating an overview of the methodology of the present invention according to one embodiment.

FIG. 2 is a diagram showing one embodiment of testing voltage associated with an applied pressure on a smart material.

FIG. 3 is a photograph of one embodiment of a smart material of the present invention which is a mixture of Terfenol-D and Elastomer Sylgard 160 Mix at 1.17 g/cm³, the smart material attached to a coil for testing.

FIG. 4 is a graph of voltage output after the application of 3 psi to the material of FIG. 3.

FIG. 5 is a photograph of one embodiment of a smart material of the present invention which is a mixture of Terfenol-D and Rubber at 1.17 g/cm³, the smart material being shown with a coil for testing.

FIG. 6 is a graph of voltage output after the application of 3 psi to the material of FIG. 5.

FIG. 7 is a photograph of EC-65 and carbon nanotubes mix at 1.13 g/cm³.

### DETAILED DESCRIPTION OF EXEMPLARY EMBODIMENTS

The present invention relates to smart materials. More particularly, but not exclusively, the present invention relates to smart materials and methods of manufacturing smart materials comprised of a mixture of a liquid conductive material and an electroactive material such as, without limitation, a magnetostrictive material or an electroceramic powder.

Generally, a smart material is considered to be a material which undergoes a controlled transformation through physical interactions. An electroactive material, as used herein, refers generally to a material whose shape is modified when a voltage is applied to it or creates a voltage when its shape is modified. The term “electroactive material” as used herein includes magnetostrictive materials, such as, but not limited to, terbium alloys such as Terbium-Dysprosium, Terbium-Dysprosium-Zinc; metglass; etc. In addition, the term “electroactive material” as used herein also includes materials such as piezoelectric materials.

The present invention provides for smart materials and methods of producing the smart materials. In particular, the present invention provides for the combination of electroactive materials in powdered form to liquids of conductive materials such as elastomers. The term “elastomer” as used herein include rubbers as well as other types of elastomers.

The present invention allows for the electroactive properties of the electroactive material to be harvested by combining the electroactive material, in a powerderized form with a conductive liquid. The resulting material can be shaped in a number of convenient forms, including as a sheet, and can be used for any number of applications including those which allow electrical energy to be harvested from the resulting material. The surface of the resulting material can be deposited with a conductive pattern, such as a coil, to assist in the harvest of electrical energy.

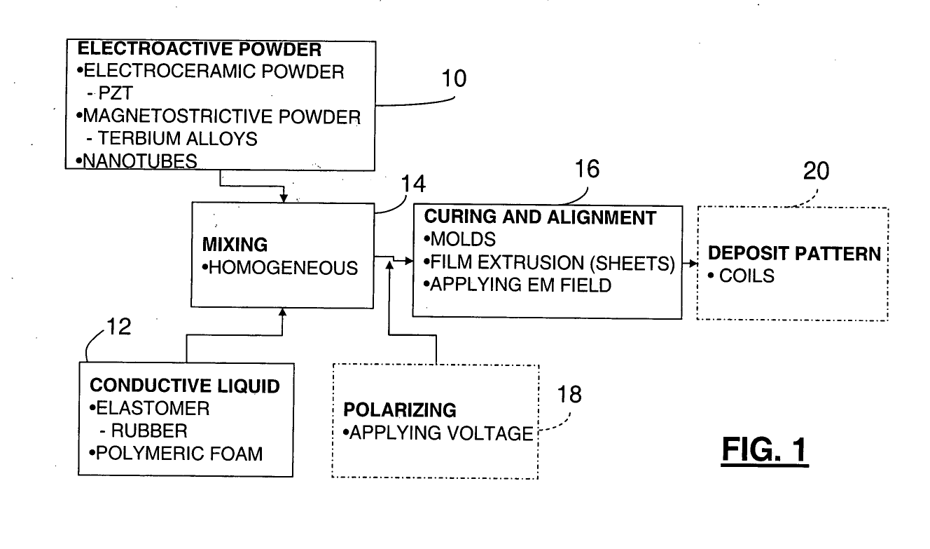

FIG. 1 illustrates preferred embodiments of the present invention. In FIG. 1, an electroactive powder 10 and a conductive liquid are mixed in step 14. The electroactive powder 10 can be an electroceramic, such as a piezoelectric material, or a PZT material. The electroactive powder 10 can also be a magetostrictive material such as a Terbium allow such as, but not limited to, Terfenol-D. In step 14, mixing take places. The mixing preferably is used to achieve a homogenous mixture. The mixing can be performed in various ways, including through sonic homogenization or through mixing performed by a batch disperser. Polarizing can also occur in step 18 through applying an appropriate voltage. Next in step 16, curing and alignment takes place. An electromagnetic field is applied to the material during curing in order to align particles within the mix. The electromagnetic field can be provided using a permanent magnet. Because of the use of a conductive liquid such as an elastomer, the resulting material can be made into any number of shapes by casting into a mold which is appropriate for a particular application. The resulting material can also be subjected to a film extrusion process to produce sheets of the smart material. In step 20, a conductive pattern can then be deposited on the resulting smart material or otherwise operatively connected to the resulting pattern. The pattern can be a pattern used to assist in harvesting of electrical energy from deformation of the smart material or for other purposes. One type of pattern that can be used is a coil pattern. Various types of deposition process can be used.

In one embodiment of the present invention an electroceramic powder is mixed in an ultrasonic container with a polymeric conductive foam fluid. Ultrasound is applied to homogeneous the mixture. One example of a ultrasound equipment that can be used is the VirSonic Ultrasonic Digital 600. One example of a suitable frequency that can be used is 20 kHz, although the present invention contemplates variations in the frequency. During the homogenization process, if polarization is desired, two electrodes are implanted into the ultrasonic container to provide for continuous polarization of the electroceramic powder with a DC voltage. One example of a DC voltage that can be applied is 50 volts with a 1000 W regulated power supply such as a CSI 5003X5. After the polymeric conductive foam fluid becomes an amorphous mass, the electrodes are removed. If a closed cell or open cell formation is required, then a DC voltage is applied again. Each cell of the resulting material produces only a small voltage when stressed, but when all of the cells are arranged in a series, a larger voltage is obtained. Thus, a material is produced which provides for sufficiently large voltages to be produced to act as a source of power. One skilled in the art having the benefit of this disclosure will appreciate that there are numerous applications for materials having these properties.

Although the present invention contemplates than any number of powderized electroceramic materials can be used, EC-65 is one example of a suitable electroceramic material. EC-65 is an electroceramic composition of lead zirconate titanate which is available from EDO Corporation. Of course, other types of electro-ceramic materials can be used, including those based on barium titanate, lead titanate, lead magnesium niobate, etc. EC-65 has a high dielectric constant with high sensitivity and has a very low aging rate and high permittivity. The present invention contemplates that different specifications may be more appropriate than others for particular applications.

In another embodiment of the present invention, the conductive liquid is combined with a magnetostrictive material. One example of a magnetostrictive material which can be used is the rare-earth alloy containing Terbium, such as Tb₃Dy₇Fe which has been commercialized under the tradename of TERFENOL-D. The magnetostrictive material is provided in powder form such that homogenization of the powder and the foam can take place. The powder can be of various mesh size. For example, the powder can vary from 0 to 300 μm size mesh, or to 500 μm size mesh. Another example of a magnetostrictive material that can be used is identified by the tradename METGLaS and is produced by SatCon Technologies Corp.

Various type of conductive liquids can also be used. For example, a conductive rubber, such as ZOFLEX ZL60.1 Pressure-Activated Conductive Rubber can be used in place of the conductive polymeric material. The conductive rubber is mixed in liquid form with the electroactive material. In another embodiment of the present invention, an elastomer such as Dow Corning two part elastomer Sylgard 170 or Sylgard 170 fast cure can be used. The present invention contemplates using any form of elastomer or silicone rubber encapsulating material. A preferred ratio is about a 1:1 ratio between the electroactive material and the elastomer.

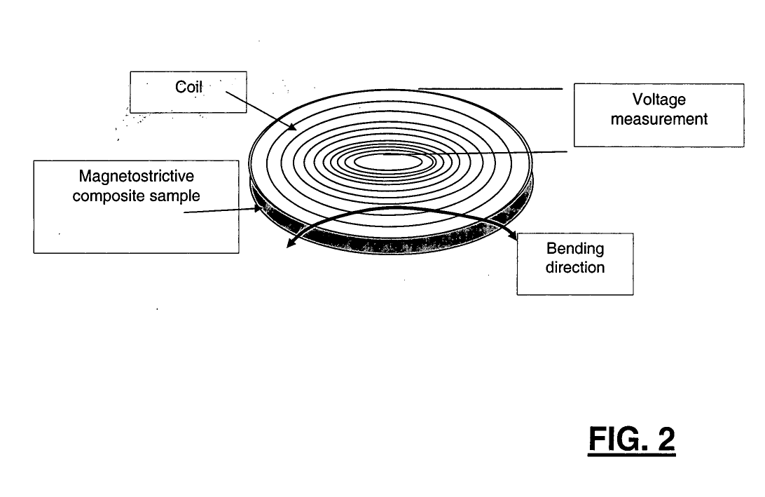

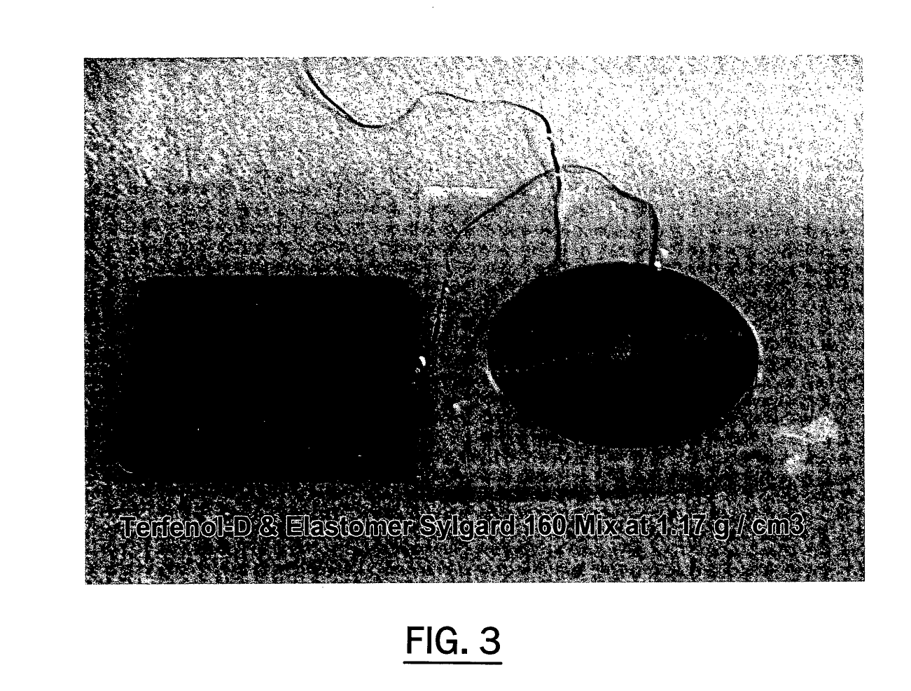

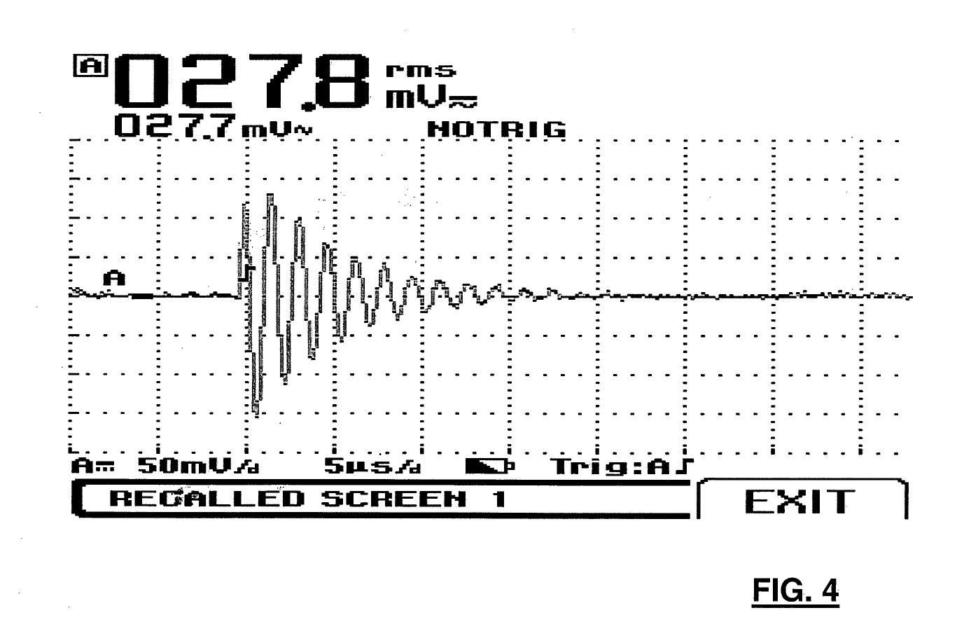

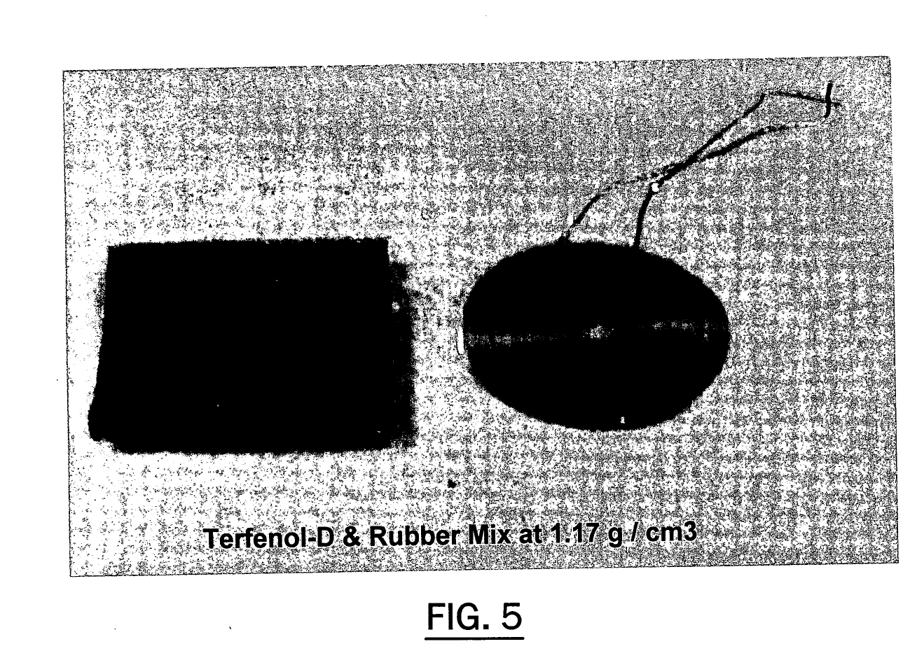

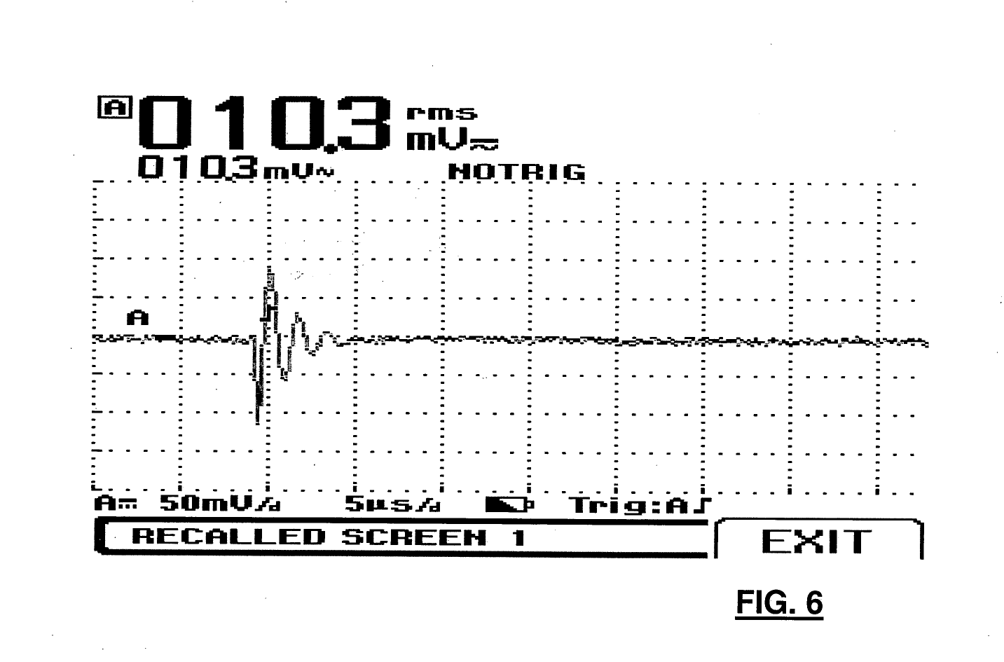

In one embodiment of the present invention a mixture of Terfenol-D and rubber at a ratio of 1.17 g/cm³ was used. In another embodiment of the present invention, a mixture of Terfenol-D and Elastomer Sylgard 160 at a ratio of 1.17 g/cm³ was used. Of course, the present invention also contemplates that more than one type of elastomer could be used in the mixture. A photograph of the composition created from the mixture of Terfenol-D and rubber at a ration of 1.17 g/cm3 is shown in FIG. 5. A photograph of the composition created from the mixture of Terfenol-D and Elastomer Sylgard 160 at a ratio of 1.17 g/cm3 is shown in FIG. 3. To test these materials, a setup as shown in FIG. 2 was used. Bending of the sample of the smart material provides tension along the top of the material and compression along the bottom of the material. Tension will rotate the electroactive particles and result in changing electromagnetic flux (a changing voltage). A coil is used to assist in capturing the resulting voltage. A 3 pounds per square inch (psi) pressure was applied to the material of FIG. 3, and resulting measured voltage is shown in FIG. 4. Similarly, a 3 psi pressure was applied to the material of FIG. 5 and the resulting measured voltage is shown in FIG. 6.

The present invention also provides for the use of conductive carbon nanotubes. According to another embodiment of the present invention, conductive carbon nanotubes are combined with polymeric foam. The obtained material is then milled into closed cell formation and can be further polarized during the curing process. The polarization process consists of applying a DC voltage of 50,000 volts on the cured material.

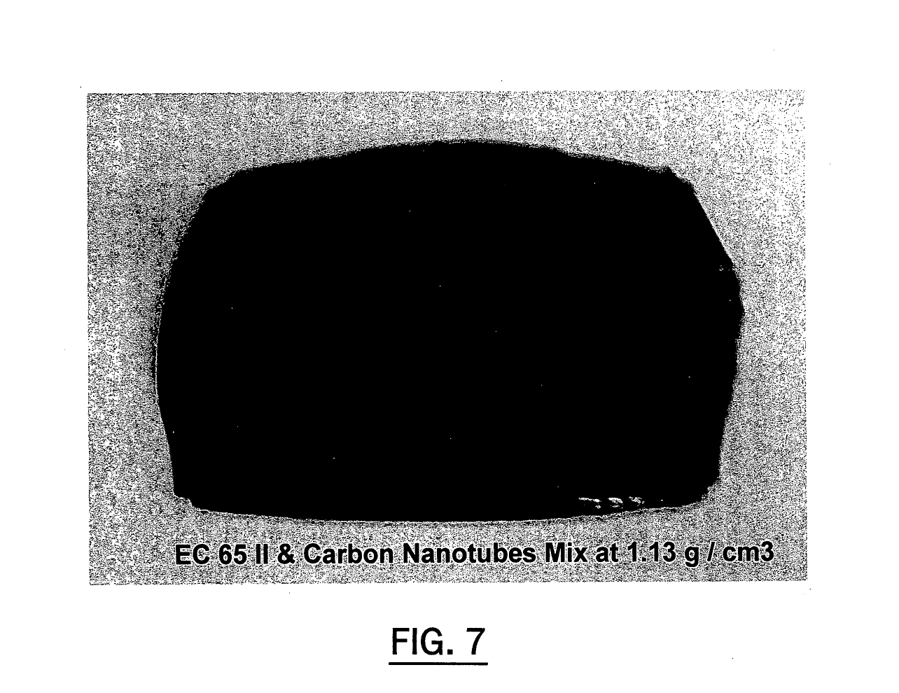

According to another embodiment of the present invention, an electroceramic powder, EC-65, and carbon nanotubes were mixed with a liquid form of rubber at 1.13 g/cm³. The addition of the carbon nanotubes further provides for desired smart material properties. FIG. 7 is a photograph illustrating the resulting composition.

As previously described, a batch disperser can be used for mixing/homogenizing. The mixture can then be placed within a casting mold with permanent magnets positioned to align the particles of the mixture. If desired, the mixture can be cured within a controlled evaporation chamber. Where a film extrusion process is used, a 2 inch film extruder, such as available from Haake can be used. A vertical 3-roll sheet stack and takeup can also be used. The rolls from the takeup are substituted with permanent cylindrical magnets with N field bottom and S field top to provide for the alignment. Thus, the molds for curing and alignment can be replaced with a film extrusion procedure which allows for particle alignment. The resulting sheets can be used in numerous ways. For example, a conductive coil can be deposited on the sheet. Alternatively, conductive coils can be sandwiched between sheets.

It should be appreciated that the resulting composition can be used in numerous ways, depending upon the specific application for which the composition is used. For example, the material can be cured or dried into strips with electrodes at each end. Of course, the material can be otherwise processed as may be appropriate for a specific use.

The present invention is not to be limited to the specific embodiments described herein, the specific materials or compositions disclosed, and the specific methods disclosed. Rather, the present invention contemplates numerous variations and alternative embodiments, all within the spirit and scope of the invention.

What is claimed is:

1. A composition comprised of a mixture of an electroactive powder and a conductive liquid.

2. The composition of claim 1 wherein the mixture is a substantially homogenized mixture.

3. The composition of claim 2 wherein the conductive liquid is an elastomer.

4. The composition of claim 3 wherein the mixture is cured.

5. The composition of claim 4 wherein the electroactive powder is powder of a magnetostrictive material.

6. The composition of claim 5 wherein the magnetostrictive material comprises a Terbium alloy.

7. The composition of claim 4 wherein the electroactive powder is an electroceramic powder.

8. The composition of claim 3 wherein the elastomer is a rubber.

9. The composition of claim 1 wherein the liquid is a polymeric foam.

10. The composition of claim 1 wherein the composition has an open cell structure.

11. The composition of claim 1 wherein the composition has a closed cell structure.

12. The composition of claim 1 wherein the powder is a Terbium alloy.

13. The composition of claim 1 wherein the mixture further comprises carbon nanotubes.

14. A method of forming a smart material composition comprising adding an electroactive powder to a conductive liquid and mixing the electroactive powder and the conductive liquid to form a mixture.

15. The method of claim 14 further comprising curing the mixture.

16. The method of claim 14 wherein the step of mixing is mixing until the mixture is substantially homogenous.

17. The method of claim 15 further comprising applying a voltage to the mixture prior to curing to polarize the mixture.

18. The method of claim 15 further comprising performing alignment on structure of the mixture.

19. The method of claim 15 wherein the step of curing is performed within a mold.

20. The method of claim 15 further comprising performing film extrusion on the mixture to thereby produce a sheet.

21. The method of claim 20 further comprising depositing a conductor in a pattern on the sheet.

22. The method of claim 21 wherein the pattern is a coil pattern.

23. A composition comprised of a cured homogenized mixture of an electroactive powder and a conductive liquid, the composition having electromagnetically aligned particles.

24. The composition of claim 23 wherein the electroactive powder is powder of a magnetostrictive material.

25. The composition of claim 23 wherein the magnetostrictive material is a Terbium alloy.

26. The composition of claim 23 wherein the conductive liquid is an elastomer.

27. The composition of claim 26 wherein the elastomer is a rubber.

28. The composition of claim 23 wherein the conductive liquid is a polymeric foam.

29. A composition comprised of a homogenized mixture of an electroactive powder, a conductive liquid, and carbon nanotubes, the composition having electromagnetically aligned particles.

30. The composition of claim 29 wherein the electroactive powder is powder of a magnetostrictive material.

31. The composition of claim 30 wherein the magnetostrictive material is a Terbium alloy.

32. The composition of claim 29 wherein the conductive liquid is an elastomer.

33. The composition of claim 29 wherein the conductive liquid is a polymeric foam.
